(19) United States
(12) Patent Application Publication
(10) Pub. No.: US 2011/0176270 A1
(43) Pub. Date: Jul. 21, 2011

(54) SYSTEM RACK FOR ACCESSING HARD DISKS IN DUAL DIRECTIONS

(76) Inventors: Ku-Yang Chou, San Jose, CA (US); Yen-Lun Lee, Fremont, CA (US)

(21) Appl. No.: 12/689,434

(22) Filed: Jan. 19, 2010

(51) Int. Cl. G06F 1/16

(52) U.S. Cl. 361/679.33

(57) ABSTRACT

A system rack includes a casing and a tray connected therein. Both sides of the casing are provided with a first opening and a second opening respectively. A first accommodating region and a second accommodating region are provided respectively adjacent to the first opening and the second opening. A portion of hard disks received in the first accommodating region can be accessed from the first opening. The second accommodating region is partitioned horizontally into a hard disk zone and a tray zone. The remaining portion of the hard disks received in the second accommodating region can be accessed from the second opening. The casing is provided with a pair of rail seats in the tray zone. The tray is connected in the tray zone. The tray is provided with a pair of rails to correspond to the rail seats. With this structure, the hard disks received in the system rack can be accessed in dual directions, thereby receiving more hard disks in the casing.

### BACKGROUND OF THE INVENTION

1. Field of the Invention

The present invention relates to a computer rack, and in particular to a rack for receiving a redundant array of independent disks.

2. Description of Prior Art

With the spread of computers and the Internet, more and more amount of data is transmitted by means of the Internet. Since there are various formats of files in digitalized data, it is an important issue for the Internet Service Providers (ISP) or computer manufacturers to provide a large amount of space for storing the data.

In order to provide a stable operating platform of enough space, a redundant array of independent disks (RAID) with capabilities of data integration, fault tolerance and data backup is proposed. A storage system equipped with the RAID has a plurality of hard disks and uses these hard disks as a single hard disk. A portion of the hard disks in this system can be set for reproducing (mirroring) data automatically so as to backup the data timely.

A conventional RAID system includes a computer rack. The interior of the rack is provided with an accommodating trough. The rack is provided with an opening near the accommodating trough. An array of hard disks is received in the accommodating trough. When repairing, the accommodating trough is accessed from the opening of the rack, thereby taking out of the respective hard disks.

According to the above-mentioned structure, since only one side of the rack is provided with the opening through which the respective hard disks can be accessed, a portion of the hard disks disposed more deeply in the rack may not be accessed easily. As a result, the number of hard disks that can be received in the accommodating trough is limited. However, nowadays, it is necessary for the RAID systems to receive more hard disks to backup or store huge amount of data. Thus, the conventional RAID system becomes insufficient for this need.

In order to solve the above drawbacks, the present Inventor proposes a reasonable structure based on his expert experience and deliberate researches.

### SUMMARY OF THE INVENTION

The present invention is to provide a system rack for accessing hard disks in dual directions, whereby hard disks received in the rack can be accessed easily.

The present invention is to provide a system rack for accessing hard disks in dual directions, in which more hard disks can be received.

The present invention is to provide a system rack for accessing hard disks in dual directions, adapted to receive a plurality of hard disks therein. The system rack includes a casing and a tray. Both sides of the casing are provided with a first opening and a second opening respectively. A first accommodating region and a second accommodating region are provided respectively adjacent to the first opening and the second opening. A portion of the hard disks received in the first accommodating region can be accessed from the first opening. The second accommodating region is partitioned horizontally into a hard disk zone and a tray zone. The remaining portion of the hard disks received in the second accommodating region can be accessed from the second opening. The casing is provided with a pair of rail seats in the tray zone. The tray is connected in the tray zone. The tray is provided with a pair of rails to correspond to the rail seats.

The present invention is to provide a system rack for accessing hard disks in dual directions, in which a host module is provided on the tray to make the system rack as a computer host. Further, other hard disks are disposed on the tray to enlarge the space of the system rack for storing data. With this structure, the flexibility of the system rack can be increased.

The present invention is to provide a system rack for accessing hard disks in dual directions, in which the interior of the casing is provided with two parallel rows of fan assemblies, thereby generating a good heat-dissipating effect.

In comparison with prior art, the system rack for accessing hard disks in dual directions according to the present invention is provided with a first opening and a second opening one both sides of the casing. A portion of the hard disks can be accessed from the first opening, and the other portion of the hard disks can be accessed from the second opening. When in use, the hard disks received in the rack can be accessed from both sides of the rack. Thus, even though more hard disks are received in the casing, they can still be accessed easily. Further, a host module or hard disk can be disposed on the tray, so that the flexibility of the system rack can be increased. Further, the interior of the casing is provided with two parallel rows of fan assemblies, so that a good heat-dissipating effect can be generated. Therefore, the convenience and practicability of the present invention can be enhanced.

### BRIEF DESCRIPTION OF THE DRAWINGS

FIG. 1 is an assembled perspective view of the present invention;

FIG. 2 is a perspective view showing the external appearance of the present invention;

FIG. 3 is a front view showing a second embodiment of the present invention;

FIG. 4 is a perspective view showing the second embodiment of the present invention; and

FIG. 5 is a perspective view showing the external appearance of a third embodiment of the present invention.

### DETAILED DESCRIPTION OF THE INVENTION

The characteristics and technical contents of the present invention will be described with reference to the accompanying drawings. However, the drawings are illustrative only but not used to limit the present invention.

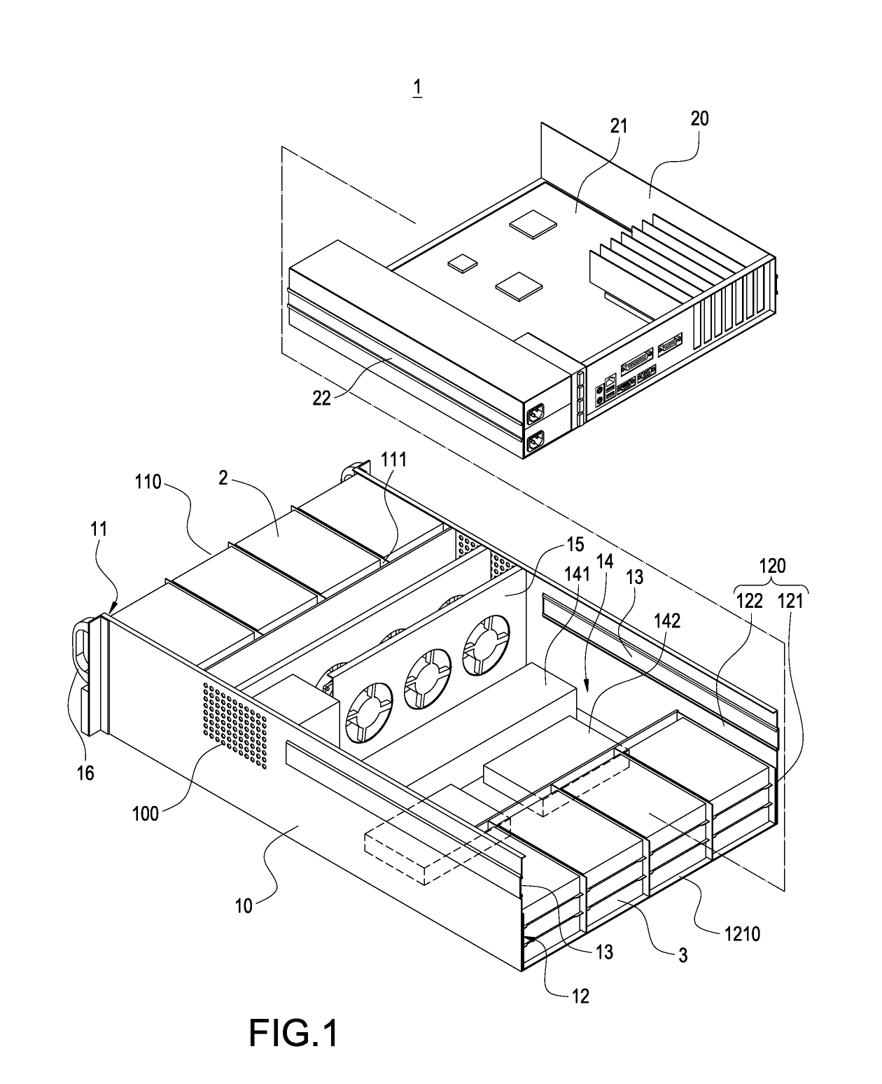

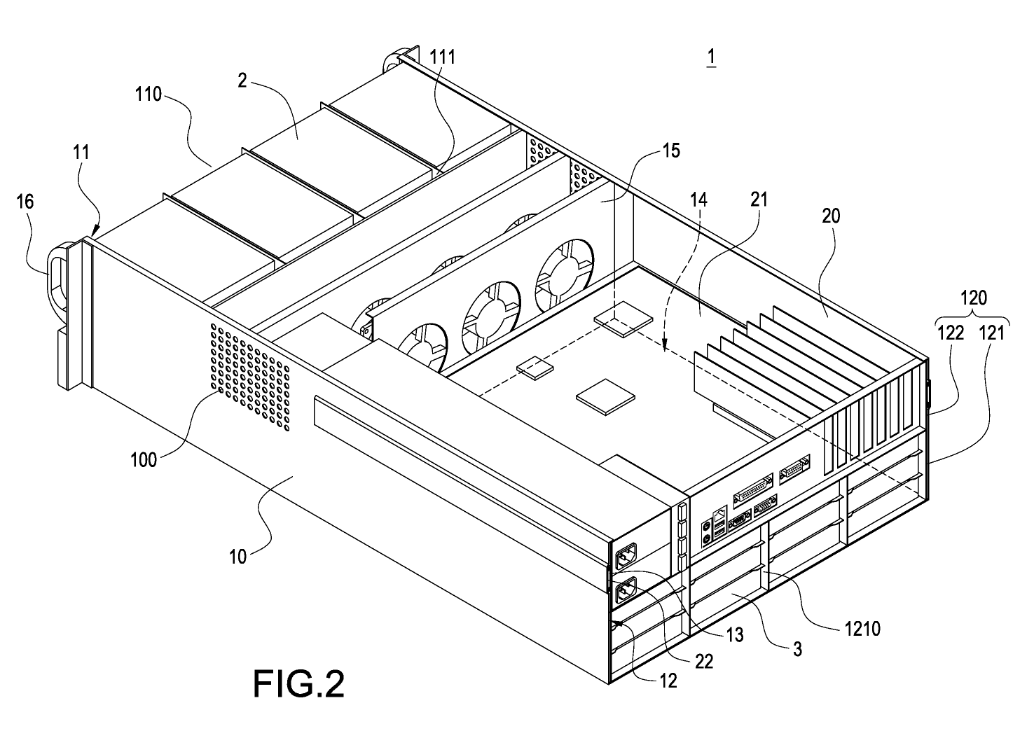

Please refer to FIGS. 1 and 2. FIG. 1 is an assembled perspective view of the present invention, and FIG. 2 is a perspective view showing the external appearance of the present invention. The present invention provides a system rack 1 for accessing hard disks in dual directions, which includes a casing 10 and a tray 20 movably connected to the casing 10.

Both sides of the casing 10 are provided with a first opening 11 and a second opening 12 respectively. A first accommodating region 110 and a second accommodating region 120 are provided respectively adjacent to the first opening 11 and the second opening 12. The first accommodating region 110 is partitioned into a plurality of first accommodating troughs 111 in which a plurality of hard disks 2 is received. The second accommodating region 120 is partitioned horizontally into a hard disk zone 121 and a tray zone 122. The hard disk zone 121 is also partitioned into a plurality of second accommodating troughs 1210 in which a plurality of hard disks 3 is received. The tray zone 122 of the casing 10 is provided with a pair of rail seats 13. In the present embodiment, each of the hard disk 2 and the hard disk 3 is a 3.5″ hard disk.

The interior of the casing 10 is provided with a third accommodating region 14 between the first accommodating region 110 and the second accommodating region 120. An uninterruptible power supply system 141, a hard disk 142 or two parallel rows of fan assemblies 15 is received in the third accommodating region 14. The two rows of fan assemblies 15 are disposed in front of the uninterruptible power supply system 141 (near the first opening 11). The casing 10 is provided with a plurality of heat-dissipating holes 100 outside the two rows of fan assemblies 15. The heat-dissipating holes 100 act as air inlets for the fan assemblies 15. Cold air is introduced by the fan assemblies 15 from the first opening 11 (or the heat-dissipating holes 100). Then, hot air is exhausted from the second opening 12. In addition, both sides of the first opening 11 of the casing 11 are provided with a handle 16 respectively. The handle 16 is formed into a U shape, so that a user can grip the handle 16 to move the casing 10.

The tray 20 is connected in the tray zone 122 of the casing 10. A host module 21 is received in the tray 20. The host module 21 is electrically connected with the hard disks 2 and the hard disks 3. The tray 20 is provided with a pair of rails 22 to correspond to the pair of rail seats 13 of the casing 10. With the cooperation of the pair of rails 22 and the rail seats 13, the tray 20 can be movably connected in the tray zone 122.

With the above structure of the system rack 1, the hard disks 2 received in the first accommodating region 11 can be accessed from the first opening 11, and the hard disks 3 received in the hard zone 121 can be accessed from the second opening 12.

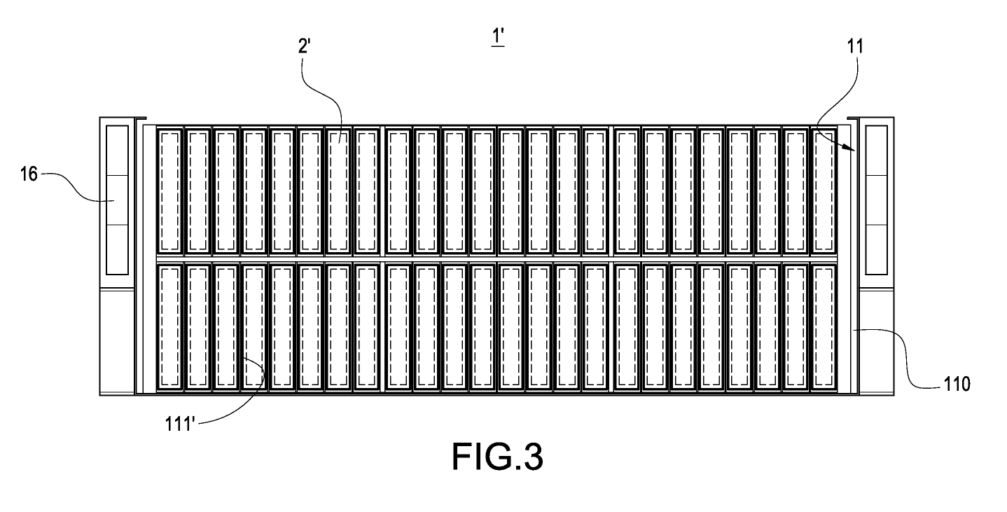

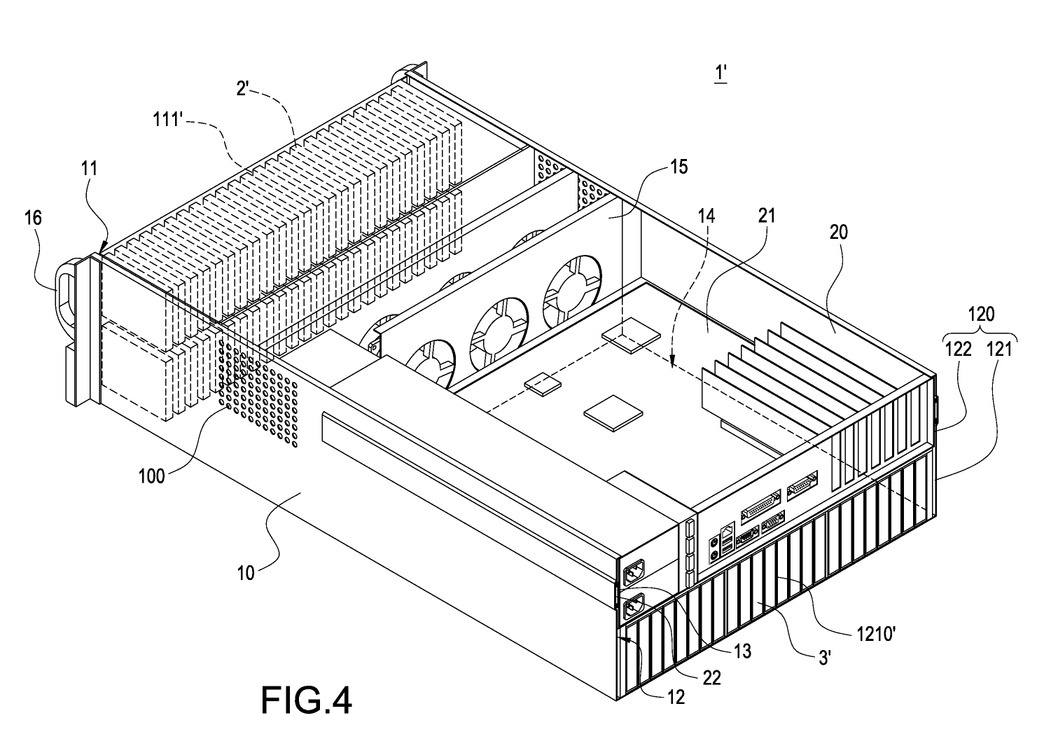

Please refer to FIGS. 3 and 4. FIG. 3 is a front view showing a second embodiment of the present invention, and FIG. 4 is a perspective view showing the second embodiment of the present invention. The system rack 1′ of the second embodiment is substantially the same as that of the first embodiment. The only difference between the second embodiment and the first embodiment is the arrangement of a plurality of first accommodating troughs 111′. A plurality of 2.5″ hard disks 2′ is received in the first accommodating troughs 111′ respectively. Similarly, a plurality of 2.5″ hard disks 2′ is received in the second accommodating troughs 1210′.

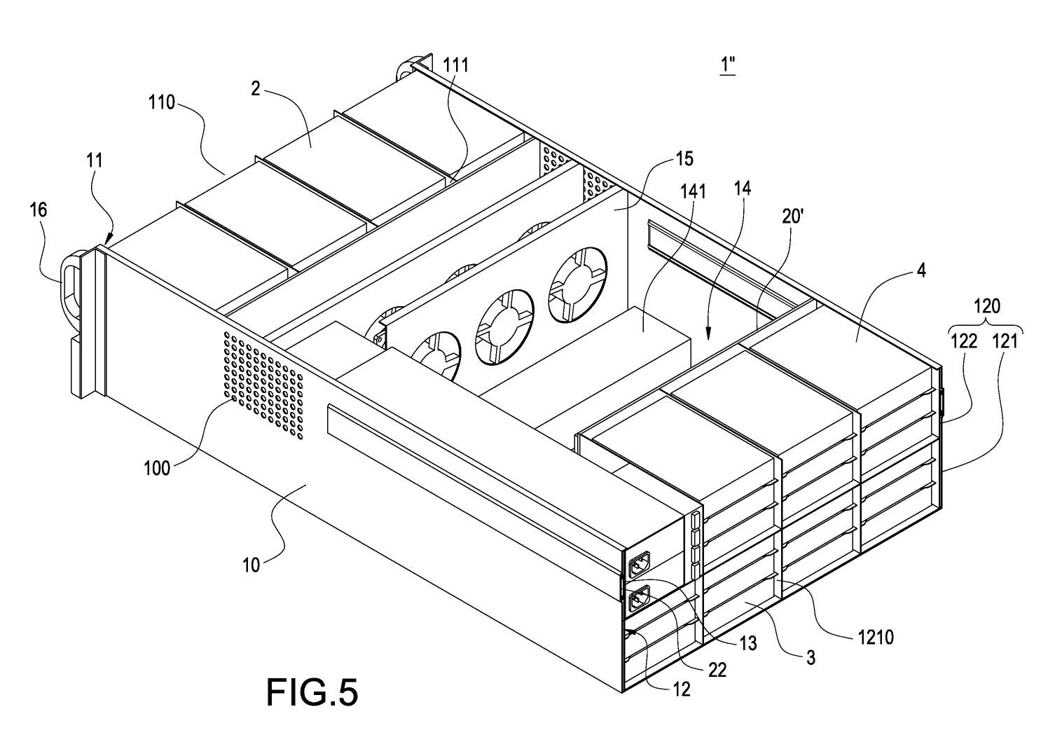

Please refer to FIG. 5, which is a perspective view showing the external appearance of a third embodiment of the present invention. The third embodiment is substantially the same as the first embodiment. The only difference between the third embodiment and the first embodiment lies in that a plurality of hard disks 4 is received in the tray 20′ of the system rack 1″.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A system rack for accessing hard disks in dual directions, adapted to receive a plurality of hard disks therein and including:
a casing with its both sides having a first opening and a second opening respectively, a first accommodating region and a second accommodating region being provided adjacent to the first opening and the second opening, respectively, a portion of the hard disks received in the first accommodating region being accessed from the first opening, the second accommodating region being partitioned horizontally into a hard disk zone and a tray zone, the other portion of the hard disks received in the hard disk zone being accessed from the second opening, the tray zone of the casing being provided with a pair of rail seats; and
a tray connected in the tray zone, the tray being provided with a pair of rails to correspond to the rail seats.

2. The system rack for accessing hard disks in dual directions according to claim 1, wherein an uninterruptible power supply system is provided between the first accommodating region and the second accommodating region in the casing.

3. The system rack for accessing hard disks in dual directions according to claim 1, wherein a hard disk is provided between the first accommodating region and the second accommodating region in the casing.

4. The system rack for accessing hard disks in dual directions according to claim 1, wherein two parallel rows of fan assemblies are provided between the first accommodating region and the second accommodating region in the casing.

5. The system rack for accessing hard disks in dual directions according to claim 1, wherein the casing is provided with a plurality of heat-dissipating holes outside the two rows of fan assemblies.

6. The system rack for accessing hard disks in dual directions according to claim 1, wherein the two rows of fan assemblies introduce air from the first opening and blow the air out of the second opening.

7. The system rack for accessing hard disks in dual directions according to claim 1, wherein the casing is provided with a handle on each side of the first opening.

8. The system rack for accessing hard disks in dual directions according to claim 1, wherein a host module is received in the tray, and the host module is electrically connected with the hard disk to make the system rack as a computer host.
